(19) United States
(12) Patent Application Publication
(10) Pub. No.: US 2002/0154679 A1
(43) Pub. Date: Oct. 24, 2002

(54) Use of a transceiver configured for frequency modulation for signals that are coded by a method for spreading spectrums

(76) Inventors: Christian Kranz, Ratingen Lintorf (DE); Andre Neubauer, Krefeld (DE)

Correspondence Address: LERNER AND GREENBERG, P.A., Post Office Box 2480, Hollywood, FL, 33022-2480, US

(21) Appl. No.: 10/146,584

(22) Filed: May 15, 2002

Related U.S. Application Data
(63) Continuation of application No. PCT/DE00/03984, filed on Nov. 13, 2000.

(30) Foreign Application Priority Data
Nov. 15, 1999 (DE) 199 54 897.8

(51) Int. Cl. H04B 1/707

(52) U.S. Cl. 375/132; 375/140; 375/308

(57) ABSTRACT

In the use of a transceiver based upon frequency modulation for signals coded by a method for spreading spectrums, a series of first data symbols having a valence M is used as a basis for assigning a series of L second binary data symbols to each of the first data symbols. In this case, the L-element series of second data symbols correspond to chip sequences used for the spectrum-spreading method. A signal containing the sequence of second data symbols is used by the transceiver for the frequency modulation.

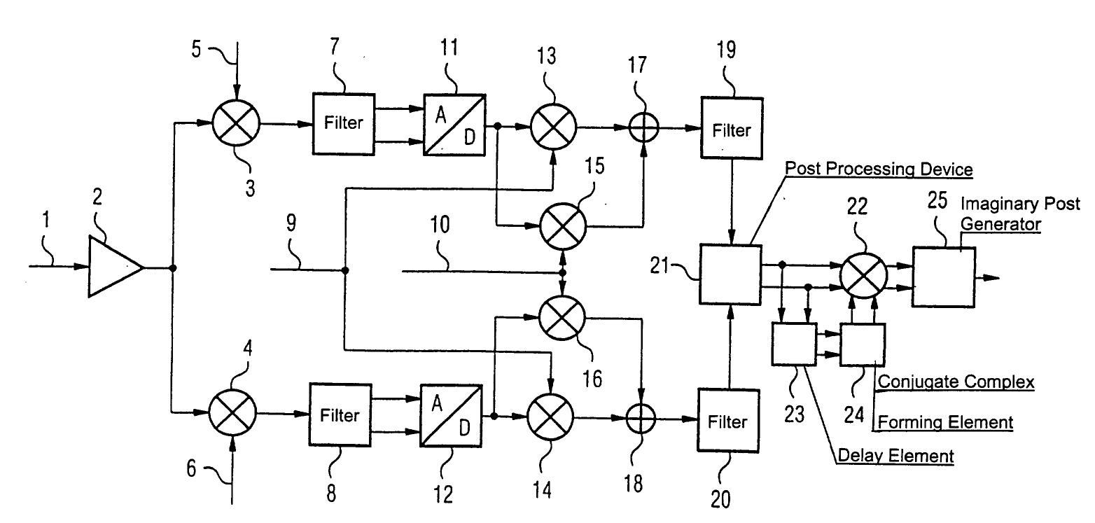

### CROSS-REFERENCE TO RELATED APPLICATION

This application is a continuation of copending International Application No. PCT/DE00/03984, filed Nov. 13, 2000, which designated the United States and which was not published in English.

### BACKGROUND OF THE INVENTION

### FIELD OF THE INVENTION

The invention relates to the use of a transceiver configured for frequency modulation for signals that are coded by a spreading spectrum method, in particular signals that are coded by a direct-sequence code division multiple access (DSCDMA) method.

For use in the industrial, medical or scientific sector, the industrial-scientific-medical (ISM) frequency band at 2.4 GHz is globally available. The frequency band can be accessed while conforming to the guidelines issued by the Federal Communications Commission (FCC) by spread spectrum technology. For example, this allows the creation of cordless phones or telecommunication systems based on radio transmission for the transmission of measured values using the ISM frequency band.

For systems that use the ISM frequency band, direct-sequence code division multiple access or frequency-hopping code division multiple access (FH-CDMA) is predominantly used as the method of accessing the radio channel. In the case of systems with DS-CDMA, phase-shift keying (PSK) modulation and in the case of systems with FH-CDMA, frequency-shift keying (FSK) modulation is usually used as the modulation method.

In many cordless telecommunication systems already on the market, such as for example digital enhanced cordless communication (DECT), worldwide digital cordless communication (WDCT) or in the case of Bluetooth systems, transceivers (transmitters/receivers) that are based on Gaussian-frequency shift keying (GFSK) modulation are used. GFSK modulation is a special form of FSK modulation in which a Gaussian low-pass filter with a prescribed bandwidth/symbol duration product BT, for example of 0.5, is used for the baseband prefiltering. Signals modulated by GFSK have a constant envelope, advantageously allowing simple transmitter amplifiers to be used. However, such telecommunication systems are not suitable, for example, for the DS-CDMA access method on account of the PSK modulation method required for this. Accordingly, in the case of such telecommunication systems, a transceiver that is suitable for the PSK modulation method, but in turn is not suitable for FSK modulation, must be used if the DS-CDMA access method is to be used.

### SUMMARY OF THE INVENTION

It is accordingly an object of the invention to provide for the use of a transceiver configured for frequency modulation for signals that are coded by a method for spreading spectrums which overcomes the above-mentioned disadvantages of the prior art methods of this general type, which makes it possible for a transceiver configured for a GFSK modulation method to be used for a DS-CDMA access method.

With the foregoing and other objects in view there is provided, in accordance with the invention, a method for using a transceiver configured for frequency modulation for signals that are coded by a method for spreading spectrums. The method uses a series of first data symbols having a valence M as a basis for assigning a series of L second binary data symbols to each of the first data symbols. The series of the L second data symbols corresponds to chip sequences used in the method of spreading spectrums. A duration of a chip sequence is extended in comparison with a duration of the first data symbols by a factor L. A signal containing a sequence of the second binary data symbols is used by the transceiver for the frequency modulation.

The idea on which the invention is based is that of coding the chip sequences used for the spectrum-spreading method by first data symbols, which are transmitted by frequency modulation. Each chip sequence in turn represents a data symbol from a multiplicity of first data symbols, the actual data to be transmitted by a spectrum-spreading method. As a result, the transceiver, which is configured for sending and receiving frequency-modulated signals, can be used without any circuit-related changes for signals coded by a spectrum-spreading method. Such transceivers are used, for example, in DECT, WDCT, SWAP or Bluetooth systems. However, in this case a reduction in the available transmission rate by a factor of L must be accepted, since the duration of a chip sequence is L-T_{bit} and precisely one first data symbol of the duration T_{bit} is coded by a chip sequence. The reduced data rate makes the invention suitable in particular for cordless phones with a TDD (Time-Division Duplex) speech connection or for the transmission of measured values with a low data rate.

The transceiver preferably sends and receives signals that are modulated by the Gaussian-Frequency Shift Keying modulation method. This modulation method is used, for example, in the case of cordless phones conforming to the DECT standard and is therefore widespread and able to be implemented with inexpensive transmitting/receiving stages.

The first data symbols are preferably binary data symbols or data symbols having the valence two, whereby the sequence assigned to a first data symbol dₙ can, depending on its value, be given in the form c_{n,v} or 1−c_{n,v}, where v=0, . . , L−1.

The signals coded by a spectrum-spreading method are preferably coded by the direct-sequence CDMA method. As a result, a transceiver operating on the basis of the GFSK method can be used without great expenditure.

In an alternative preferred use, the transceiver is suitable for frequency hopping and the signals coded by a spectrum-spreading method are coded by a frequency-hopping CDMA method (FH-CDMA). This provides the possibility of using it both for DS-CDMA-coded signals and for FH-CDMA-coded signals. Such a transceiver is then switched over according to the coding of the signals to be sent and received.

The transceiver preferably sends and receives signals in the ISM frequency bands (ISM band: Industrial-Scientific-Medical band). As an example, mention may be made here of the 2.4 GHz frequency band, which is authorized by the Federal Communications Commission for use in industry, science and medicine, and can be used for example for the transmission of measured values by radio.

For example, a transmitter from the DECT or WDCT system, which operates on the open-loop principle, may be used for the transceiver. Alternatively, however, transmitters operating on the closed-loop principle, such as for example a ΣΔ-modulated fractional-N PLL frequency synthesizer may also be used.

Other features which are considered as characteristic for the invention are set forth in the appended claims.

Although the invention is illustrated and described herein as embodied in the use of a transceiver configured for frequency modulation for signals that are coded by a method for spreading spectrums, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a block diagram of a receiver of a transceiver used for explaining the method according to the invention.

### DESCRIPTION OF THE PREFERRED EMBODIMENTS

Referring now to the single FIGURE of the drawing, there is shown a receiver that amplifies a radio-frequency received signal 1 with a low-noise amplifier 2 (LNA: Low-Noise Amplifier) and passes I and Q components of the amplified received signal to a first multiplier 3 and a second multiplier 4, respectively. The first multiplier 3 multiplies the supplied signal (I component) by a carrier frequency 5, to obtain from the received signal 1 a baseband received signal. By analogy, the second multiplier 4 multiplies the supplied signal (Q component) by a carrier frequency 6, likewise to obtain from the received signal 1 a baseband received signal.

The components of the received signal, “mixed down” in this way to the baseband received signals, are in each case fed to a first anti-aliasing filter 7 and a second anti-aliasing filter 8, to satisfy the Shannon sampling theorem for a digitization of the baseband received signals.

The low-pass-filtered signals are digitized, shifted in their frequency, filtered and fed to a differential demodulator by a first analog/digital converter 11 and a second analog/digital converter 12. Alternatively, instead of a differential demodulator, an analog FM demodulator, used in DECT or WDCT systems, may be used on the basis of the limiter-discriminator principle. However, on account of the non-linearities of the analog FM demodulator, sacrifices in interference suppression must be expected.

The frequency converter has third to sixth multipliers 13 to 16 and a first adder 17 and second adder 18. The third multiplier 13 and the fourth multiplier 14 multiply the supplied digitized signal by a first control signal 9, parallel to which the fifth multiplier 15 and the sixth multiplier 16 multiply the supplied digitized signal by a second control signal 10. The first control signal 9 and the second control signal 10 correspond to the two signal components in the modulation of the transmitted signal on which the received signal is based in a transmitter, which signal components are used for generating the binary transmitted signal. The output signal of the third multiplier 13 and of the fifth multiplier 15 or the output signal of the fourth multiplier 14 and of the sixth multiplier 16 is added by a first adder 17 or by a second adder 18 and fed to a first filter 19 or a second filter 20, respectively.

The first filter 19 and the second filter 20 filter the demodulated signals and feed them to a post-processing device 21, which normalizes and brings together the two signals. The output signal of the post-processing device 21 is fed to a differential demodulator, containing a multiplier 22 and a delay element 23, disposed parallel to the latter, and also a downstream element 24 for forming the conjugate complex. The output signal of the element 24 is likewise fed to the multiplier 22 and multiplied by the output signal of the post-processing device 21. The output signal of the seventh multiplier 22 is fed to an imaginary-part generator 25, which filters the imaginary part out of the supplied signal.

The use according to the invention is explained below on the basis of a simple exemplary embodiment.

Binary data symbols dₙε{0, 1} are coded in the case of DSCDMA by chip sequences <c_{n, 0}, . . . , c_{n,L-1}> with chips c_{n,v}ε{0, 1}. The chip sequences have in this case a length L. The binary data bit dₙ=1 is transmitted by sending out a chip sequence <c_{n,0}, . . . , c_{n,L-1}> and the binary data bit dₙ=0 is transmitted by sending out the inverted chip sequence <1−c_{n,0}, . . . , 1−c_{n,L-1}>. The use of such chip sequences in cordless telecommunications systems within the ISM frequency band serves for suppressing narrowband interference signals, which have a less disturbing influence in the case of the broadband CDMA method than in the case of a narrowband access method such as F/TDMA (Frequency/Time-Division Multiple Access). The FCC defines a minimum processing gain for suppressing interference signals, which has to be satisfied by telecommunications systems that use the ISM band, in order to avoid or suppress possible interference signals. To maintain the minimum processing gain stipulated by the FCC, transceivers for signals modulated by the (G)FSK modulation method may be used for the DS-CDMA access method.

For this purpose, the bits d′ₖ of a signal modulated by (G)FSK are merely assigned to the chips of the above chip sequences: d′ₖ=c_{n,v} for the binary data bit dₙ=1 and d′ₖ=1−c_{n,v} for the binary data bit dₙ=0, where k=n·L+v . Consequently, the bit rate T′_{bit} of the signal modulated by (G)FSK corresponds to the chip bit rate T_{chip}. By this simple mapping, a DS-CDMA system can be created. The bandwidth/duration product BT′bit of the Gaussian low-pass filter of the (G)FSK system consequently similarly applies to the DS-CDMA system. The resulting bit rate T_{bit} of the DS-CDMA system corresponds to a bit rate T′_{bit} of the (G)FSK system: 1/T_{bit}=1/(T′_{bit} L), reduced by the length L of the chip sequence.

In a hard decision, a detection of the chips c_{n,v} takes place in a receiver like a detection of the bits d′ₖ of the signal modulated by (G)FSK. A decision for the sent bit dₙ=1 or dₙ=0 takes place in this case in the receiver by a comparison of the received chip sequence with the undisturbed chip sequences <c_{n,0}, . . . , c_{n,L-1}> for the bit dₙ=1 and <1−c_{n,0}, . . . , 1−c_{n,L-1}> for the bit dₙ=0. Alternatively, a soft decision may also take place in the case of an output signal of the demodulator available with higher accuracy.

We claim:

1. A method for using a transceiver configured for frequency modulation for signals that are coded by a method for spreading spectrums, which comprises the steps of:
using a series of first data symbols having a valence M as a basis for assigning a series of L second binary data symbols to each of the first data symbols, the series of the L second data symbols corresponding to chip sequences used in the method of spreading spectrums, a duration of a chip sequence having been extended in comparison with a duration of the first data symbols by a factor L; and
using a signal containing a sequence of the second binary data symbols by the transceiver for the frequency modulation.

2. The method according to claim 1, which comprises using the transceiver to send and receive signals modulated by a Gaussian-frequency shift keying modulation method.

3. The method according to claim 1, which comprises forming the first data symbols as one of binary data symbols and data symbols having the valence two, it being provided that, on condition that the series containing the L second data symbols assigned to a first data symbol value is referred to as c_{n,v}, v =0, . . . , L−1, and a second data symbol value is assigned the series 1−c_{n,v}.

4. The method according to claim 1, which comprises using a direct-sequence code division multiple access method as the method for spreading spectrums for coding the signals.

5. The method according to claim 1, which comprises forming the transceiver to be suitable for frequency hopping and using a frequency-hopping code division multiple access method as the method for spreading spectrums used for coding the signals.

6. The method according to claim 1, which comprises setting up the transceiver to send and receive signals in a frequency band of 2.4 GHz.
